(19) United States
(12) Patent Application Publication
(10) Pub. No.: US 2015/0170516 A1
(43) Pub. Date: Jun. 18, 2015

(54) SYSTEM AND METHOD FOR OUTPUTTING DISTANCE LINKAGE ALARM OF VEHICLE

(71) Applicant: Hyundai Motor Company, Seoul (KR)

(72) Inventor: Jae-Jun Lee, Anyang (KR)

(21) Appl. No.: 14/523,620

(22) Filed: Oct. 24, 2014

(30) Foreign Application Priority Data
Dec. 17, 2013 (KR) 10-2013-0157652

(51) Int. Cl. G08G 1/123; B60Q 5/00

(52) U.S. Cl. CPC G08G 1/123; B60Q 5/001

(57) ABSTRACT

A system and a method for outputting a distance linkage alarm of a vehicle are provided. The system includes a remote controller key that is configured to transmit a radio frequency (RF) signal for transmitting vehicle operating information based on a user's operation. In addition, a vehicle controller is configured to execute a vehicle operation based on the operating information of the received RF signal and adjust an alarm output generated when the vehicle operates based on the operating information, at a plurality of levels by considering a received signal strength indication (RSSI) of the RF signal received depending on a distance between the remote controller key and the vehicle.

### CROSS-REFERENCE TO RELATED APPLICATION

This application claims priority to and the benefit of Korean Patent Application No. 10-2013-0157652 filed in the Korean Intellectual Property Office on Dec. 17, 2013, the entire contents of which are incorporated herein by reference.

### BACKGROUND

(a) Field of the Invention

The present invention relates to a system and a method for outputting a distance linkage alarm of a vehicle.

(b) Description of the Related Art

In a shopping complex in which large-scale discount stores and department stores are concentrated, a complex parking lot having passages associated with a plurality of buildings is installed underground to reduce traffic congestion at a ground layer. Further, even for a large-scale apartment complex which has been built in recent years, green land facilities for a residential environment have increased outdoor and a large-scale parking lot facility to which the entire complex is connected has been provided underground. To locate a vehicle parked in a parking lot having a wide and complex structure, a user needs to accurately determine a parking location, and when the user does not remember the parking location, the user experiences inconvenience of searching the parking lot to locate the parked vehicle.

Meanwhile, in general, a vehicular remote controller key is used for the user to lock and unlock a vehicle door in a place distant from the vehicle, and the vehicle outputs a predetermined alarm when the door lock and unlock is operated. In particular, the alarm may also be called a burglar alarm, a burglar horn, and verification sound and is collectively called the alarm in a description which is continued hereinbelow.

By using such a point, many users operate the vehicular remote controller key to be locked or unlocked to determine the location of the vehicle in the parking lot, and determine the position of the vehicle by referring to the alarm of the vehicle. However, when the vehicle is nearby (e.g., within a predetermined distance) when the user operates the remote controller key, the user may be alarmed by the noise of the verification sound. Additionally, when the vehicle is distant in a space such as a large-scale parking lot where the vehicles are concentrated, the user may not hear the alarm even though the user operates the remote controller key or it may be difficult for the user to identify the parking location due to the sound not being loud enough.

The above information disclosed in this section is merely for enhancement of understanding of the background of the invention and therefore it may contain information that does not form the prior art that is already known in this country to a person of ordinary skill in the art.

### SUMMARY

The present invention provides a system and a method for outputting a distance linkage alarm of a vehicle that adjust an output of a vehicle alarm at a plurality of levels by considering a received signal strength indication of an radio frequency (RF) signal of a remote controller key based on a distance between a user and the vehicle, thereby decreasing a displeasure caused by an alarm and more easily determining a vehicle position.

An exemplary embodiment of the present invention provides a system for outputting a distance linkage alarm of a vehicle that may include: a remote controller key configured to transmit a radio frequency (RF) signal for transmitting vehicle operating information based on a user's operation; and a vehicle controller configured to operate a vehicle operation based on the operating information of the received RF signal, and adjust an alarm output generated when the vehicle operates based on the operating information, at a plurality of levels by considering a received signal strength indication (RSSI) of the RF signal received based on a distance between the remote controller key and the vehicle.

Another exemplary embodiment of the present invention provides a method for outputting a distance linkage alarm of a vehicle, that may include: a) receiving an RF signal based on an operation of a remote controller key; b) measuring a received signal strength indication (RSSI) of the RF signal based on a distance between the remote controller key and the vehicle and outputting a voltage value which may be varied based on the measured RSSI of the RF signal; c) determining an output level of the voltage value based on predetermined output voltage value level setting information; and d) outputting an alarm volume having a magnitude that correspond to the determined output level when the vehicle operates based on operating information of the RF signal.

According to the exemplary embodiments of the present invention, the output level of the vehicle alarm may be automatically adjusted by considering a receiving strength of a remote controller key signal based on the distance between the user and the vehicle, thus reducing a displeasure caused by the alarm and allow an easier method of determining a vehicle position.

Further, hardware and mechanical changes of the existing system are not required and only a logic of the vehicle controller that processes the RF signal of the remote controller key is changed to simplify a system configuration. The alarm output may be controlled or the alarm operating time may be controlled based on the distance between the user and the vehicle to verify the alarm in various schemes.

### BRIEF DESCRIPTION OF THE DRAWINGS

FIG. 1 is an exemplary block diagram illustrating a configuration of a system for outputting a distance linkage alarm of a vehicle according to an exemplary embodiment of the present invention;

FIG. 2 illustrates an exemplary graph for dividing a received signal strength indication (RSSI) of an RF signal into a plurality of levels according to an exemplary embodiment of the present invention; and

FIG. 3 is an exemplary flowchart schematically illustrating a method for outputting a distance linkage alarm of a vehicle according to an exemplary embodiment of the present invention.

### DETAILED DESCRIPTION

It is understood that the term “vehicle” or “vehicular” or other similar term as used herein is inclusive of motor vehicles in general such as passenger automobiles including sports utility vehicles (SUV), buses, trucks, various commercial vehicles, watercraft including a variety of boats and ships, aircraft, and the like, and includes hybrid vehicles, electric vehicles, combustion, plug-in hybrid electric vehicles, hydrogen-powered vehicles and other alternative fuel vehicles (e.g. fuels derived from resources other than petroleum).

Although exemplary embodiment is described as using a plurality of units to perform the exemplary process, it is understood that the exemplary processes may also be performed by one or plurality of modules. Additionally, it is understood that the term controller/control unit refers to a hardware device that includes a memory and a processor. The memory is configured to store the modules and the processor is specifically configured to execute said modules to perform one or more processes which are described further below.

Furthermore, control logic of the present invention may be embodied as non-transitory computer readable media on a computer readable medium containing executable program instructions executed by a processor, controller/control unit or the like. Examples of the computer readable mediums include, but are not limited to, ROM, RAM, compact disc (CD)-ROMs, magnetic tapes, floppy disks, flash drives, smart cards and optical data storage devices. The computer readable recording medium can also be distributed in network coupled computer systems so that the computer readable media is stored and executed in a distributed fashion, e.g., by a telematics server or a Controller Area Network (CAN).

The terminology used herein is for the purpose of describing particular embodiments only and is not intended to be limiting of the invention. As used herein, the singular forms “a”, “an” and “the” are intended to include the plural forms as well, unless the context clearly indicates otherwise. It will be further understood that the terms “comprises” and/or “comprising,” when used in this specification, specify the presence of stated features, integers, steps, operations, elements, and/or components, but do not preclude the presence or addition of one or more other features, integers, steps, operations, elements, components, and/or groups thereof. As used herein, the term “and/or” includes any and all combinations of one or more of the associated listed items.

Unless specifically stated or obvious from context, as used herein, the term “about” is understood as within a range of normal tolerance in the art, for example within 2 standard deviations of the mean. “About” can be understood as within 10%, 9%, 8%, 7%, 6%, 5%, 4%, 3%, 2%, 1%, 0.5%, 0.1%, 0.05%, or 0.01% of the stated value. Unless otherwise clear from the context, all numerical values provided herein are modified by the term “about.”

Hereinafter, exemplary embodiments of the present invention will be described more fully hereinafter with reference to the accompanying drawings, in which exemplary embodiments of the invention are shown. As those skilled in the art would realize, the described exemplary embodiments may be modified in various different ways, all without departing from the spirit or scope of the present invention. The drawings and description are to be regarded as illustrative in nature and not restrictive. Like reference numerals designate like elements throughout the specification.

In addition, the terms “-er”, “-or” and “module” described in the specification mean units for processing at least one function and operation and can be implemented by hardware components or software components and combinations thereof.

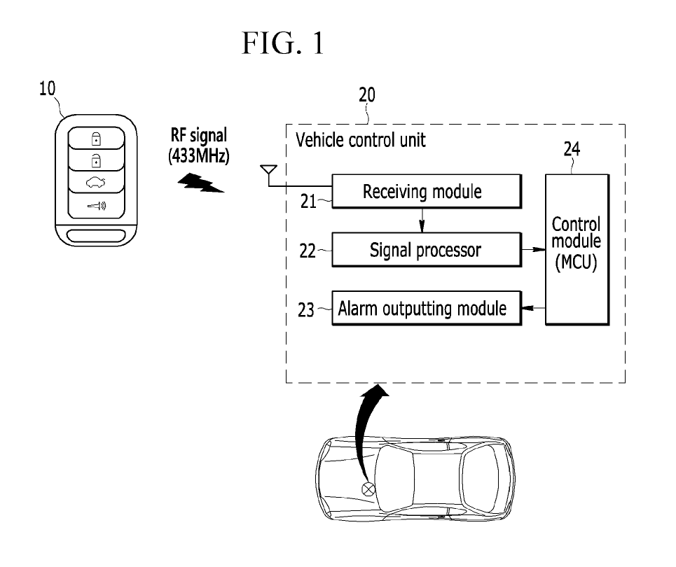

Hereinafter, a system and a method for outputting a distance linkage alarm of a vehicle according to exemplary embodiments of the present invention will be described in detail with reference to the accompanying drawings. FIG. 1 is an exemplary block diagram illustrating a configuration of a system for outputting a distance linkage alarm of a vehicle according to an exemplary embodiment of the present invention.

Referring to FIG. 1, the system for outputting a distance linkage alarm of a vehicle according to the exemplary embodiment of the present invention may include a remote controller key 10 configured to transmit a radio frequency (RF) signal for transmitting vehicle operating information by a user's operation, and a vehicle controller 20 configured to operate a function of the vehicle based on operating information of a received RF signal. The remote controller key 10 may be configured to execute at least one vehicle operation of a door lock, a door unlock, trunk opening, window opening/closing, a panic operation, and a remote start of the vehicle through transmission of the operating information.

In particular, the vehicle controller 20 according to the exemplary embodiment of the present invention may be configured to operate an alarm output (volume), generated when the vehicle operates, at a plurality of levels by considering a received signal strength indication (RSSI) of the RF signal received based on a distance between the remote controller key 10 and the vehicle. In addition, the vehicle controller 20 may include a receiving module 21, a signal processor 22, an alarm outputting module 23, and a control module 24 (e.g., a multipoint control unit “MCU”).

When the receiving module 21 receives an RF signal transmitted from the remote controller key 10 via an RF receiving antenna, the receiving module 21 may be executed by the controller 20 to output the received RF signal to the signal processor 22. The signal processor 22 may be configured to maintain a sleep mode state to decrease constant dark current, and when the received signal strength indication of the RF signal received by the receiving module 21 is greater than a predetermined threshold value, the signal processor 22 may be switched to a wake-up mode and processes the signal. For example, when the signal processor 22 receives an RF signal of which the receiving strength is greater than the threshold value, the signal processor 22 may be configured to wake up (e.g., enter an on mode from a sleep mode) and recognize unique identification information (ID) in a frame of the received RF signal.

Further, when the signal processor 22 determines that the received ID is available, the signal processor 22 may be configured to transfer the recognized ID to the control module 24 to process corresponding operating information or when the recognized ID and a registered ID are different from each other and the recognized ID is not available, the signal processor 22 may be configured to disregard the recognized ID and returns to the sleep mode.

Meanwhile, since the remote controller key 10 may be configured to ensure a life span of at least two years using a substantially small battery, there is limitation in outputting the RF signal. For example, the remote controller key 10 may be configured to transmit an RF signal of about 433 MHz and the receiving module 21 may be configured to receive an RF signal within a range of approximately 30 m. In particular, the received signal strength indication (RSSI) of the RF signal received by the receiving module 21 may be stronger when a user, that is, the remote controller key 10 is within a closer distance (e.g., is within a smaller range below a predetermined distance), and the received signal strength indication (RSSI) thereof may be weaker when the user, that is, the remote controller key 10 is within a longer distance (e.g., within a larger range above a predetermined distance). Accordingly, the signal processor 22 may be configured to measure the received signal strength indication (RSSI) of the RF signal transferred via the receiving module 21 to output a vehicle alarm by distance linkage, and output voltage based on the measured received signal strength indication (RSSI) of the RF signal.

The alarm outputting module 23 may be a buckler alarm horn (B/A horn) or a buzzer, and may be executed by the controller 20 to output an alarm for each function operation based on a control signal applied by receiving the RF signal. When the control signal based on a level of the received signal strength indication of the RF signal is applied, the alarm outputting module 23 may be configured to vary and output the volume of the alarm based on the level stepwise. The control module 24 may be configured to switch the sleep mode to the wake-up mode when the available RF signal is output from the signal processor 22 and determine operating information of the corresponding RF signal to adjust a related function. For example, the control module 24 may be configured to operate at least one function of door unlock/lock of the vehicle, trunk opening, window opening/closing, a panic operation, and a remote start in link with a related controller in the vehicle based on the operating information. In particular, the control module 24 may be configured to set the output voltage value of the signal processor 22 to level 0 (no signal), level 1 (weak signal), level 2 (medium signal), and level 3 (strong signal) depending on a received signal strength and store the different levels.

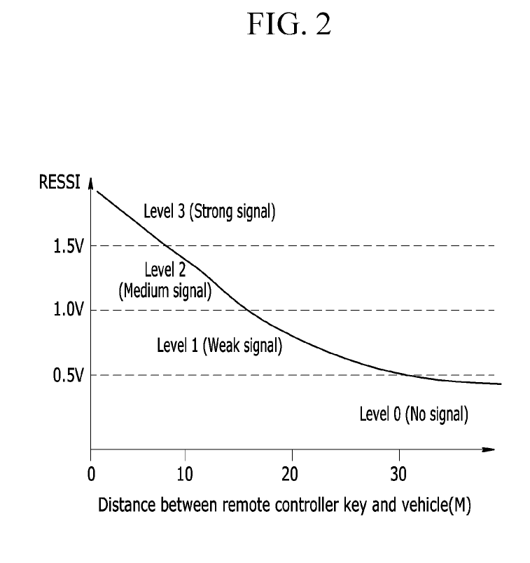

FIG. 2 illustrates an exemplary graph for dividing a received signal strength indication (RSSI) of an RF signal into a plurality of levels according to an exemplary embodiment of the present invention. Referring to FIG. 2, the control module 24 of the vehicle controller 20 according to the exemplary embodiment of the present invention may be configured to divide and set the voltage value, which may be output in link with (e.g., according to) the received signal strength indication (RSSI) of the RF signal in the signal processor 22, as level 0 (no signal) which may be less than about 0.5 V, level 1 (weak signal) which may be equal to or greater than about 0.5 V and less than about 1.0 V, level 2 (medium signal) which may be equal to or greater than about 1.0 V and less than about 1.5 V, and level 3 (strong signal) which may be equal to or greater than about 1.5 V.

In particular, each output level may define the received signal strength indication (RSSI) of the RF signal for each section, and each output level may increase as a distance between the remote controller key 10 and the vehicle decreases and may decrease as the distance between the remote controller key 10 and the vehicle increases. Herein, it is described that the control module 24 may be configured to divide the output level depending on the received signal strength indication of the RF signal in steps 0 to 3, but the output level is not limited thereto and may be increased or decreased by adjusting a software tuning value.

The control module 24 may be configured to determine the output level of the signal processor 22 and apply the control signal to adjust the volume of the alarm to a magnitude inversely proportional to the verified output level. In other words, the control module 24 may be configured to adjust the increase of the volume magnitude of the alarm when the output level depending on the received signal strength indication of the RF signal is decreased and adjust the decrease of the volume magnitude of the alarm when the output level is increased to output the alarm in link with the distance between the remote controller key 10 and the vehicle.

Further, the control module 24 may be configured to increase an operating time of the alarm when the output level that depends on the received signal strength indication of the RF signal is decreased and may be configured to decrease the operating time of the alarm when the output level is increased to adjust the alarm operating time in link with the distance between the remote controller key 10 and the vehicle. In particular, the alarm operating time may be adjusted by a scheme that adjusts a time when the alarm operates once or increases or decreases the number of times of operating the alarm.

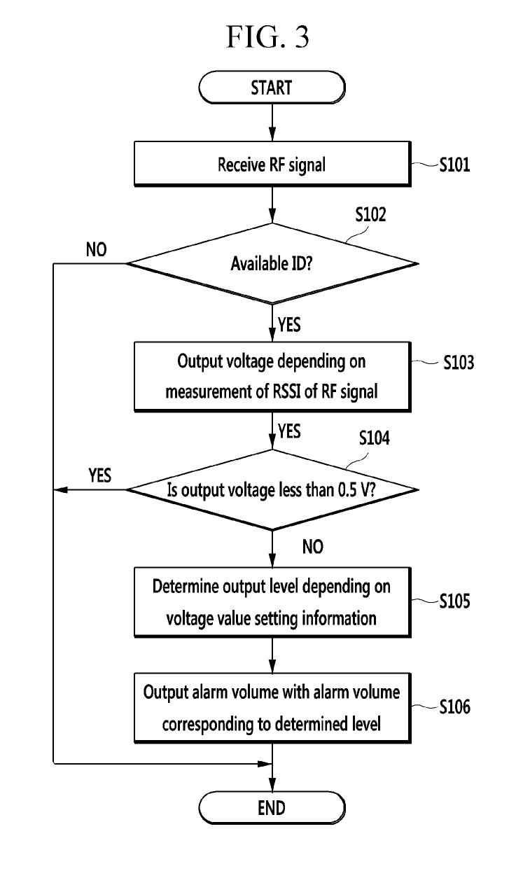

Meanwhile, a method for outputting a distance linkage alarm of a vehicle, which is based on the configuration of the system for outputting the distance linkage alarm of the vehicle according to the exemplary embodiment of the present invention, will be described through FIG. 3 below. FIG. 3 is an exemplary flowchart schematically illustrating a method for outputting a distance linkage alarm for a vehicle according to an exemplary embodiment of the present invention.

Referring to FIG. 3 which is accompanied, when the vehicle controller 20 according to the exemplary embodiment of the present invention receives the RF signal from the remote controller key 10 (S101), the vehicle controller 20 may be configured to determine an ID by analyzing the received RF signal and compare the acquired ID with the registered ID to determine whether the acquired ID is available (S102).

When the vehicle controller 20 determines that the ID is different from the registered ID and the ID is not available (S102; No), the vehicle controller 20 may be configured to disregard the RF signal and operate in the sleep mode. Additionally, when the vehicle controller 20 determines that the ID is the same as the registered ID and the ID is available (S102; Yes), the vehicle controller 20 may be configured to measure the received signal strength indication of the RF signal (RSSI) and output a voltage value which may vary based on the received signal strength indication (RSSI) of the RF signal (S103).

When the voltage value output depending on the RSSI is less than about 0.5 V (step 0), the vehicle controller 20 may be configured to determine the corresponding signal as noise and disregard the corresponding signal (S104; Yes). Further, when the output voltage value is equal to or greater than about 0.5 V (S104; No), the vehicle controller 20 may be configured to determine an output level based on predetermined output voltage value setting information (S105) and output the volume of the alarm that corresponds to the determined output level when the vehicle operates based on the operating information (S106). For example, the vehicle controller 20 may be configured to output and adjust the volume of the alarm as described below by referring to the setting information of FIG. 2.

The vehicle controller 20 may be configured to determine that the user (e.g., the remote key controller 10) is positioned in a long distance (e.g., at a predetermined distance from the vehicle) and output the alarm volume with a highest magnitude, when the output voltage value depending on the RSSI of the RF signal is at level 1 which is a lowest signal (weak signal). Further, the vehicle controller 20 may be configured to determine that the user is positioned in a medium distance (e.g., within a predetermined range from the vehicle) and output the alarm volume with a normal magnitude, when the output voltage value depending on the RF RSSI is at level 2 which is normal (medium signal). In addition, the vehicle controller 20 may be configured to determine that the user is positioned within a short distance (e.g., within a predetermined range from the vehicle) and output the alarm volume with a lowest magnitude, when the output voltage value depending on the RF RSSI is at level 3 which is a highest signal (strong signal). The vehicle controller 20 may be configured to output the alarm by differentially adjusting the operating time of the alarm when the alarm volume depending on the output level is output.

As described above, according to the exemplary embodiment of the present invention, the output level of the vehicle alarm may be automatically adjusted by considering a receiving strength of a remote controller key signal depending on the distance between the user and the vehicle, thereby reducing a displeasure caused by the alarm and more easily determining a vehicle position.

Hardware and mechanical changes of the existing system are not required and only a logic of the vehicle controller that processes the RF signal of the remote controller key may be changed to simplify a system configuration. The alarm output may be adjusted or the alarm operating time may be adjusted in accordance with the distance between the user and the vehicle to verify the alarm in various schemes.

The above-mentioned exemplary embodiments of the present invention are not embodied only by an apparatus and method. Alternatively, the above-mentioned exemplary embodiments may be embodied by a program performing functions, which correspond to the configuration of the exemplary embodiments of the present invention, or a recording medium on which the program is recorded. These exemplary embodiments may be easily devised from the description of the above-mentioned exemplary embodiments by those skilled in the art to which the present invention pertains.

While this invention has been described in connection with what is presently considered to be practical exemplary embodiments, it is to be understood that the invention is not limited to the disclosed exemplary embodiments, but, on the contrary, is intended to cover various modifications and equivalent arrangements included within the spirit and scope of the accompanying claims.

### DESCRIPTION OF SYMBOLS

10: Remote controller key

20: Vehicle controller

21: Receiving module

22: Signal processor

23: Alarm outputting module

24: Control module

What is claimed is:

1. A system for outputting a distance linkage alarm of a vehicle, comprising:
a remote controller key configured to transmit a radio frequency (RF) signal for transmitting vehicle operating information based on a user operation; and
a vehicle controller having a memory and a processor configured to:
execute a vehicle operation depending on the operating information of the received RF signal;
adjust an alarm output generated when the vehicle operates based on the operating information at a plurality of levels by considering a received signal strength indication (RSSI) of the RF signal received depending on a distance between the remote controller key and the vehicle.

2. The system of claim 1, wherein:
the remote controller key is configured to execute at least one vehicle operation of a group consisting of: a door lock, a door unlock, a trunk opening, a window opening and closing, a panic operation, and a remote start of the vehicle through transmission of the operating information.

3. The system of claim 1, wherein the vehicle controller is configured to:
receive the RF signal via an RF receiving antenna;
measure the received signal strength indication of the RF signal and output voltage depending on the received strength;
store an output voltage value by setting a plurality of output levels in accordance with a received signal strength; and
vary and output a volume magnitude of the alarm depending on the applied output level, when a control signal based on the output level of the RSSI of the RF signal is applied.

4. The system of claim 3, wherein the vehicle controller is configured to:
maintain a sleep mode state to decrease constant dark current, and when the RSSI of the RF signal is greater than a predetermined threshold value, switch the sleep mode to a wake-up mode and process the signal.

5. The system of claim 3, wherein the vehicle controller is configured to:
set the plurality of output levels by dividing the output voltage value into level 0 which is less than about 0.5 V, level 1 which is equal to or greater than about 0.5 V and less than about 1.0 V, level 2 which is equal to or greater than about 1.0 V and less than about 1.5 V, and level 3 which is equal to or greater than about 1.5 V.

6. The system of claim 3, wherein the vehicle controller is configured to:
increase the alarm volume magnitude as the output level depending on the RSSI of the RF signal decreases; and
decrease the alarm volume magnitude as the output level increases.

7. The system of claim 6, wherein the vehicle controller is configured to:
increase an operating time of the alarm as the RSSI of the RF signal decreases; and
decrease the operating time of the alarm as the output level increases.

8. A method for outputting a distance linkage alarm of a vehicle, comprising:
receiving, by a controller, an radio frequency (RF) signal depending on a user operation from a remote controller key;
measuring, by the controller, a received signal strength indication (RSSI) of the RF signal depending on a distance between the remote controller key and the vehicle and outputting a voltage value varied depending on the measured RSSI of the RF signal;
determining, by the controller, an output level of the voltage value based on predetermined output voltage value level setting information; and
outputting, by the controller, an alarm volume having a magnitude that corresponds to the determined output level when the vehicle operates depending on operating information of the RF signal.

9. The method of claim 8, further comprising:
storing, by the controller, the output voltage value varied depending on the RSSI of the RF signal by setting the output voltage value at a plurality of output levels in accordance with the RSSI.

10. The method of claim 8, wherein outputting the alarm volume includes:
outputting, by the controller, the alarm volume with a highest magnitude when the output voltage value is at level 1 which is a lowest level;
outputting, by the controller, the alarm volume with a normal magnitude when the output voltage value is at level 2 which is a normal level; and
outputting, by the controller, the alarm volume with a lowest magnitude when the output voltage value is at level 3 which is a highest level.

11. The method of claim 10, wherein:
an operating time of the alarm is differentially adjusted when the alarm volume is output depending on the output level.

12. The method of claim 11, wherein:
the operating time of the alarm is differentially adjusted by adjusting a time when the alarm is operated once or increasing or decreasing the number of times of operating the alarm.

13. The method of claim 8, wherein receiving the RF signal includes:
acquiring, by the controller, an identification information (ID) by analyzing the received RF signal, comparing the ID with a registered ID, and determining whether the ID is available; and
disregarding, by the controller, the RF signal and operating in a sleep mode in response to determining that the ID is different from the registered ID and the ID is unavailable.

14. The method of claim 10, wherein level 1 is equal to or greater than about 0.5 V and less than about 1.0 V, level 2 is equal to or greater than about 1.0 V and less than about 1.5 V, and level 3 is equal to or greater than about 1.5 V.

15. A non-transitory computer readable medium containing program instructions executed by a controller, the computer readable medium comprising:
program instructions that receive an radio frequency (RF) signal depending on a user operation from a remote controller key;
program instructions that measure a received signal strength indication (RSSI) of the RF signal depending on a distance between the remote controller key and the vehicle and outputting a voltage value varied depending on the measured RSSI of the RF signal;
program instructions that determine an output level of the voltage value based on predetermined output voltage value level setting information; and
program instructions that output an alarm volume having a magnitude that corresponds to the determined output level when the vehicle operates depending on operating information of the RF signal.

16. The non-transitory computer readable medium of claim 15, further comprising:
program instructions that store the output voltage value varied depending on the RSSI of the RF signal by setting the output voltage value at a plurality of output levels in accordance with the RSSI.

17. The non-transitory computer readable medium of claim 15, wherein outputting the alarm volume includes:
program instructions that output the alarm volume with a highest magnitude when the output voltage value is at level 1 which is a lowest level;
program instructions that output the alarm volume with a normal magnitude when the output voltage value is at level 2 which is a normal level; and
program instructions that output the alarm volume with a lowest magnitude when the output voltage value is at level 3 which is a highest level.

18. The non-transitory computer readable medium of claim 17, wherein:
an operating time of the alarm is differentially adjusted when the alarm volume is output depending on the output level.

19. The non-transitory computer readable medium of claim 17, wherein level 1 is equal to or greater than about 0.5 V and less than about 1.0 V, level 2 is equal to or greater than about 1.0 V and less than about 1.5 V, and level 3 is equal to or greater than about 1.5 V.

20. The non-transitory computer readable medium of claim 18, wherein:
the operating time of the alarm is differentially adjusted by adjusting a time when the alarm is operated once or increasing or decreasing the number of times of operating the alarm.
